(19) United States
(12) Patent Application Publication
(10) Pub. No.: US 2004/0131221 A1
(43) Pub. Date: Jul. 8, 2004

(54) Speaker surround and method for producing the same

(76) Inventors: Koji Takayama, Tendo-shi (JP); Satoshi Hachiya, Tendo-shi (JP); Takashi Suzuki, Tendo-shi (JP)

Correspondence Address: YOUNG & THOMPSON, 745 SOUTH 23RD STREET 2ND FLOOR, ARLINGTON, VA, 22202

(21) Appl. No.: 10/676,109

(22) Filed: Oct. 2, 2003

(30) Foreign Application Priority Data
Oct. 2, 2002 (JP) P2002-289647

(51) Int. Cl. H04R 1/00; H04R 9/06

(52) U.S. Cl. 381/398; 381/424

(57) ABSTRACT

A speaker surround is provided with a roll part with the curved central part, installed along the periphery of a cone-shaped speaker cone paper (diaphragm), a plane part to fix it to a frame, a junction part to join it to the speaker cone paper (diaphragm), and a reinforcing member installed inside the speaker surround. The reinforcing member is a mesh member installed inside the speaker surround and deforms easily according to the displacement of the speaker cone paper (diaphragm), however it has a structure and an arrangement with no expansion and contraction upon deforming. The mesh article is sandwiched between materials such as urethane foam and integrated by for example heat molding. As material of the reinforcing member, aromatic polyamide fiber, cotton, polyester fiber, olefin fiber, nylon fiber and the like are mentioned, which are formed in mesh by plain weaving, honeycomb weaving, triaxial weaving or the like.

### BACKGROUND OF THE INVENTION

1. Field of the Invention

This invention belongs to the art of a speaker surround and a method for producing the same which is installed between a speaker cone paper (diaphragm) and a frame of a speaker.

2. Description of the Related Art

Recent speakers are required, owing to prevalence of high-quality music sources, high-quality audio output, in particular with less distortion even for high-power input. In order to reproduce especially super bass audio or high-power input in high-quality, it is necessary to vibrate a speaker cone paper with displacement sufficiently and without strain by making a support system of the speaker cone paper flexible.

As shown in FIG. 1, in a conventional speaker, a speaker surround 10 has been used to support a speaker cone paper 14 on a frame 31. In this speaker surround 10, a heat-molded member made of such as urethane are widely employed which is equipped with: a roll part 11 in which the central part, installed along the circumvent of a cone-shaped speaker cone paper 14, is a curved convex; a plane part 12 to fix it to a frame 31; and a junction part 13 to join it to a speaker cone paper 14.

With input to speaker, the speaker cone paper 14 vibrates back and forth, and each point on the surface of the roll part 11 of the speaker surround 10 moves in the radial direction. That is, when it moves forth, each point on the surface moves outward, and when moving backward, it moves inward, so that the speaker surround 10 supports the speaker cone paper 14 on the frame 31 against driving force generated at a voice coil ranging from subtle to large amount of input to the speaker, as well as deforms according to the vibration of the speaker cone paper 14 to ensure smooth movement of the speaker cone paper 14.

However, the conventional speaker surround highly expands and contracts in the direction of displacement and does not have sufficient strength, if with large amount of input the speaker surround vibrates sympathetically, generating unnecessary vibration (unnecessary excursion) such as sideways motion, which causes deterioration of tone quality. Furthermore, there exists a problem of easily tearing at the limit of amplitude. Also when using speaker with cabinet, a suction phenomenon of the edge may be caused because of insufficient strength, resulting in decrease in audio pressure or destruction of speaker cone paper.

### SUMMARY OF THE INVENTION

This invention therefore has been made in view of the above problems, and the object of the invention is to provide a speaker surround which is suitable for a speaker which enables to reproduce high-quality sound of high-quality music sources with no tearing of speaker surround even with large amount of input to speaker nor a suction phenomenon of an edge at a speaker with cabinet, and a method for producing the same.

The above object of the present invention can be achieved by a speaker surround of the present invention arranged between a speaker cone paper (diaphragm) and a frame of a speaker. The speaker surround is provided with: a reinforcing member installed inside urethane foam, the reinforcing member being the one with no expansion and contraction upon deformation based on the displacement of the speaker cone paper.

The above object of the present invention can be also achieved by a method of the present invention for producing a speaker surround comprising a mesh reinforcing member inside urethane foam. The method is provided with the processes of: sandwiching the reinforcing member between thermoplastic resin films; and fusion bonding the urethane foam and the reinforcing member by hot-press molding.

The above object of the present invention can be also achieved by a method of the present invention for producing a speaker surround comprising a mesh reinforcing member inside urethane foam. The method is provided with the processes of: impregnating the mesh reinforcing member with urethane resin, acrylic resin, polyvinyl alcohol resin, phenol resin, melamine resin or latex mixed phenol resin; and fusion bonding the urethane foam and the reinforcing member by hot-press molding.

The above object of the present invention can be also achieved by a method of the present invention for producing a speaker surround comprising a mesh reinforcing member inside urethane foam. The method is provided with the processes of: fusing the mesh reinforcing member by hot-press molding; and fusion bonding the mesh reinforcing member to the urethane foam.

The above object of the present invention can be also achieved by a method of the present invention for producing a speaker surround comprising a mesh reinforcing member inside urethane foam. The mesh reinforcing member has large weave texture or stitch. In addition, the method is provided with the processes of: contacting the urethane foam arranged on both sides of the reinforcing member directly to the reinforcing member via the weave texture or stitch; and fusion bonding the urethane foam on both sides to the reinforcing member by hot-press molding.

The above object of the present invention can be also achieved by a method of the present invention for producing a speaker surround comprising a mesh reinforcing member inside urethane foam. The method is provided with the processes of: applying solvent or emulsion adhesive to urethane; sandwiching a mesh reinforcing member by the urethane; and fusion bonding the urethane and reinforcing member by hot-press molding.

### BRIEF DESCRIPTION OF THE DRAWINGS

FIG. 1 is a diagram showing the structure of the prior art speaker surround;

FIG. 2 is a diagram showing the structure of a speaker surround according to the invention;

FIG. 3 is a diagram showing the first example of a speaker surround according to the invention;

FIG. 4 is a diagram showing the second example of a speaker surround according to the invention;

FIG. 5 is a diagram showing the third example of a speaker surround according to the invention; and

FIG. 6 is a diagram showing an example in which a speaker surround according to the invention is employed for a speaker.

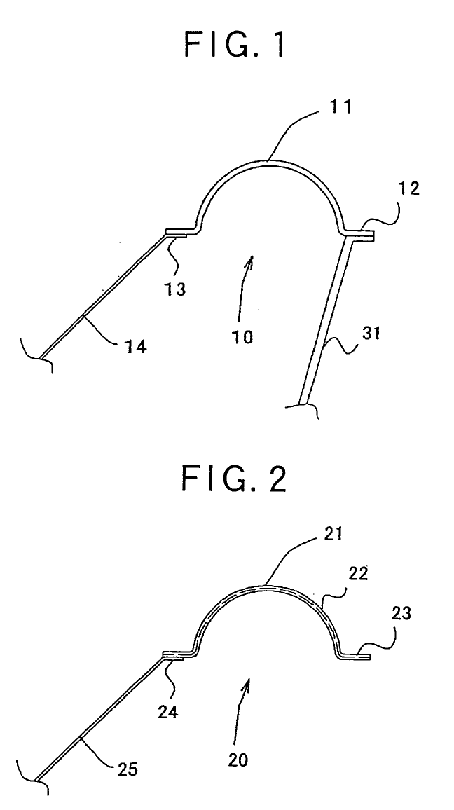

### PREFERRED EMBODIMENTS OF THE INVENTION

The preferred embodiments of this invention are now described in the following.

A speaker surround according to the invention is the one which is installed between a speaker cone paper (diaphragm) and a frame of a speaker, a reinforcing member being equipped inside urethane foam, and the reinforcing member is with no expansion and contraction upon deformation based on displacement of the speaker cone paper.

According to a speaker surround of the preferred embodiments of the invention, the edge has a multilayer structure with a reinforcing member sandwiched inside urethane foam. This reinforcing member should have a structure and an arrangement with no expansion and contraction upon deformation based on displacement of the frame. By the reinforcing member, strength of speaker surround will be increased, no unnecessary vibration such as sideways motion will occur even if with large amplitude input to speaker, and furthermore, tearing of it will be prevented even at the limit of amplitude. Also, when using a speaker with a cabinet, a suction phenomenon of an edge will be prevented to occur. A speaker employing the speaker surround according to the invention therefore reproduces high-quality audio in a wide input level range.

Here, “with no expansion and contraction” means that a mesh will not expand and contract substantially under the condition that a speaker is driven by signal supplied, a speaker cone paper vibrates at given amplitude and also a speaker surround moves at a given displacement.

As an aspect of the speaker surround according to the preferred embodiments of the invention, the reinforcing member is a mesh reinforcing member.

According to this aspect, by using a mesh member as a reinforcing member, the speaker surround will obtain sufficient strength and also easily deform according to displacement of a speaker cone paper.

As other aspect of the speaker surround according to the preferred embodiments of the invention, the reinforcing member is made of any one of aromatic polyamide fiber, cotton, polyester fiber, olefin fiber, and nylon fiber.

According to this aspect, as the reinforcing member, aromatic polyamide fiber, cotton, polyester fiber, olefin fiber, nylon fiber and the like can be employed suitably because of strength and deformability thereof. However, any material can be employed as long as it has similar property, without limiting to these materials.

As other aspect of the speaker surround according to the preferred embodiments of the invention, the reinforcing member is composed of any one of plain weave, honeycomb weaving, and triaxial weave.

According to this aspect, as the reinforcing member, plain weave, honeycomb weaving, triaxial weave and the like can be employed suitably because of strength and deformability thereof. Especially, honeycomb weaving mesh is highly effective against further large amplitude because of homogeneous load distribution on the edge which leads to uniform strength distribution. However, any material can be employed as long as it has similar property, without limiting to these materials.

As other aspect of the speaker surround according to the preferred embodiments of the invention, the reinforcing article is made of any one of nonwoven fabric and triaxial combined nonwoven fabric.

According to this aspect, as the reinforcing member, unwoven fabric, triaxial combined nonwoven fabric and the like can be employed suitably because of strength and deformability thereof. However, any material can be employed as long as it has similar property, without limiting to these materials.

The method for producing a speaker surround according to the preferred embodiments of the invention is a method for producing a speaker surround equipped with a mesh reinforcing member inside urethane foam, in which method the reinforcing member is sandwiched between thermoplastic resin films and the urethane foam and the reinforcing member are fusion bonded by hot-press molding.

According to the method for producing a speaker surround according to the preferred embodiments of the invention, the speaker surround is produced by sandwiching a reinforcing member between thermoplastic resin films and fusion bonding urethane foam and the reinforcing member by hot-press molding.

As one aspect of the method for producing a speaker surround according to the preferred embodiments, nylon is employed as the thermoplastic resin film.

According to this aspect, as thermoplastic resin film nylon is suitably employed.

As other aspect of the method for producing a speaker surround according to the preferred embodiments of the invention, ethylene vinyl acetate copolymer is employed as the thermoplastic resin film.

According to this aspect, as thermoplastic resin film ethylene vinyl acetate copolymer is suitably employed.

As other aspect of the method for producing a speaker surround according to the preferred embodiments of the invention, polypropylene is employed as the thermoplastic resin film.

According to this aspect, as thermoplastic resin film polypropylene is suitably employed.

The method for producing a speaker surround according to the preferred embodiments of the invention is a method for producing a speaker surround equipped with a mesh reinforcing member inside urethane foam, in which method the mesh reinforcing member is impregnated with urethane resin or acrylic resin, polyvinyl alcohol resin, phenol resin, melamine resin or latex mixed phenol resin, and then the urethane foam and the reinforcing member is fusion bonded by hot-press molding.

According to the method for producing a speaker surround according to the preferred embodiments of the invention, a speaker surround is produced by impregnating a mesh reinforcing member with urethane resin or acrylic resin, polyvinyl alcohol resin, phenol resin, melamine resin or latex mixed phenol resin, and fusion bonding urethane foam and the reinforcing member by hot-press molding.

The method for producing a speaker surround according to the preferred embodiments of the invention is a method for producing a speaker surround equipped with a mesh reinforcing member inside urethane foam, in which method the mesh reinforcing member is fused by hot-press molding to fusion bond it to the urethane foam.

According to the method for producing a speaker surround according to the preferred embodiments of the invention, a speaker surround is produced by fusing a mesh reinforcing member by hot-press molding and fusion bonding it to urethane foam.

The method for producing a speaker surround according to the preferred embodiments of the invention is a method for producing a speaker surround equipped with a mesh reinforcing member inside urethane foam, in which method the mesh reinforcing member with large weave texture or stitch is employed, the urethane foam arranged on both sides of the reinforcing member is contacted directly to the member via the weave texture or stitch, and the urethane foam on both sides is fusion bonded to the article by hot-press molding.

According to the method for producing a speaker surround according to the preferred embodiments of the invention, a speaker surround is produced by employing the mesh reinforcing member with large weave texture or stitch, contacting urethane foam on both sides directly to the member via the weave texture or stitch, and fusion bonding urethane foam on the both sides to the article by hot-press molding.

The method for producing a speaker surround according to the preferred embodiments of the invention is a method for producing a speaker surround equipped with a mesh reinforcing member inside urethane foam, in which method solvent or emulsion adhesive is applied to the urethane, a mesh reinforcing member is sandwiched between the urethane, and the urethane and the reinforcing member is fused by hot-press molding.

According to the method for producing a speaker surround according to the preferred embodiments of the invention, a speaker surround is produced by applying solvent or emulsion adhesive to urethane, sandwiching a mesh reinforcing member with the urethane, and fusing the urethane and the reinforcing article by hot-press molding.

These actions and other benefits of the invention are evident 25 from the example described below.

### EXAMPLES

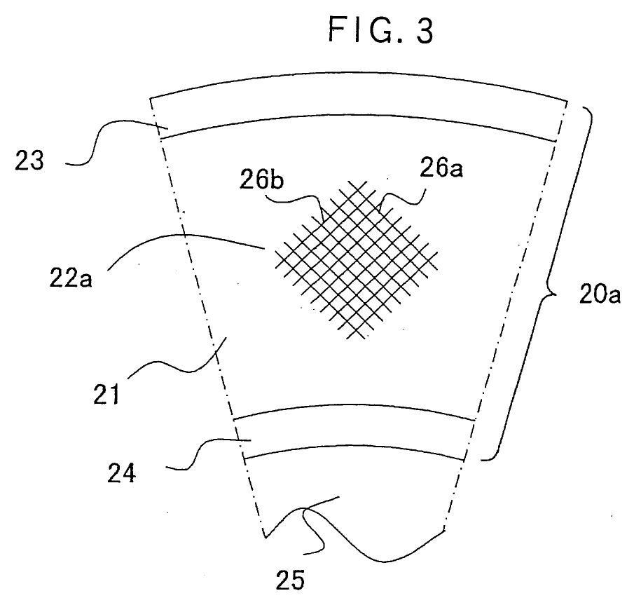

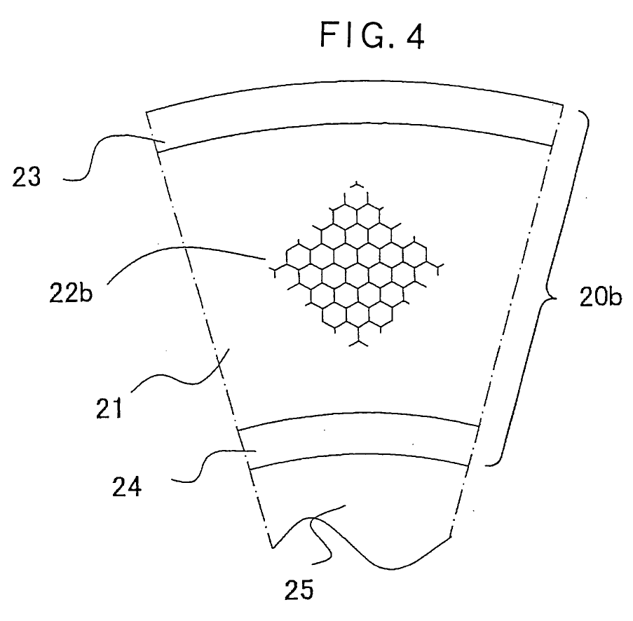

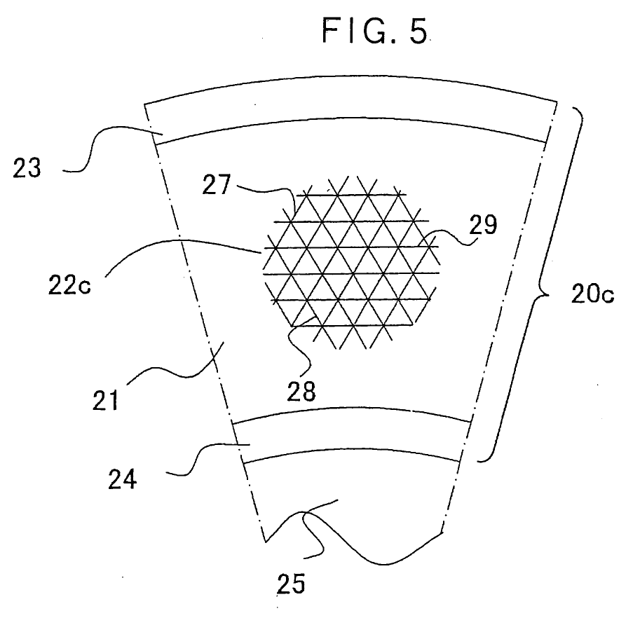

A speaker surround according to the invention is now described with reference to FIG. 2 to FIG. 5. Here, FIG. 2 is a diagram showing the structure of the speaker surround according to the invention. FIG. 3 is a diagram showing the first example of a speaker surround according to the invention, FIG. 4 is a diagram showing the second example of the invention, and FIG. 5 is a diagram showing the third example of the invention.

As shown in FIG. 2, the structure of the speaker surround 20 according to the invention is equipped with a roll part 21 which has a convex part with the curved central part and is installed along the periphery of a cone-shaped speaker cone paper (diaphragm) 25, a plane part 23 to fix it to a frame, and a junction part 24 to join it to the speaker cone paper 25, and inside the speaker surround 20 is equipped with a reinforcing member 22.

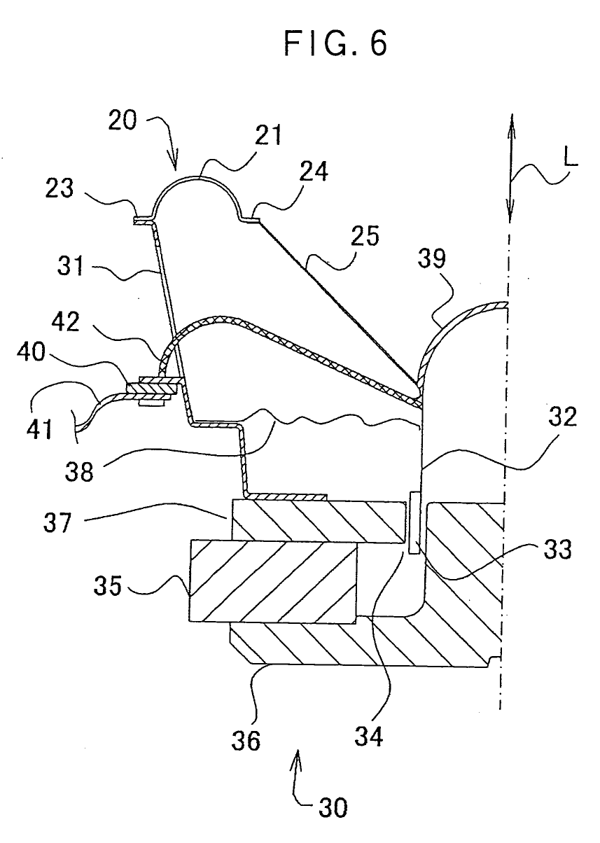

The roll part 21 is a curved part with a given radius and installed along the periphery of the speaker cone paper 25. It deforms according to the displacement of the speaker cone paper 25 to ensure smooth movement of the speaker cone paper 25 as well as to fix it to the frame (see numeral mark 31 in FIG. 6). The plane part 23 is the site to fix the edge to the frame 31 and the junction part 24 is the one to fix it to the speaker cone paper 25.

The reinforcing member 22 is a mesh member installed inside the speaker surround 20, which is sandwiched between material such as urethane foam and integrated by for example heat molding. As material of the reinforcing member 22, for example, aromatic polyamide fiber, cotton, polyester fiber, olefin fiber, nylon fiber and the like can be mentioned, which are molded into mesh in a form of plain weave, honeycomb weaving, triaxial weave and the like.

The reinforcing member 22 has a structure with no substantial flexibility in direction of displacement. Thus, under a condition wherein the speaker is driven by signal supplied, the speaker cone paper 25 vibrates with given amplitude, and therefore the speaker surround 20 also moves at a given displacement, mesh will generate substantial expansion and contraction. It will be realized by the material, mesh structure itself, arrangements thereof and the like.

Therefore, as the speaker surround 20 equipped with the abovementioned reinforcing member 22 has sufficient strength property, and the speaker cone paper 25 and the frame 31 can be joined firmly, concerns of reduction the audio quality by generation of unnecessary vibration such as sideways motion which results from sympathetic vibration of the speaker surround will be reduced, even with large amount of input. Tearing problem at the limit of amplitude will also be solved. Furthermore, even if a speaker is used with cabinet, no suction phenomenon of an edge due to insufficient strength will not occur, enabling reproduction of high-quality sound.

### First Example

As shown in FIG. 3, the speaker surround 20a according to the first example of the invention is equipped with a roll part 21 with the curved central part, installed along the periphery of a cone-shaped speaker cone paper 25, a plane part 23 to fix it to a frame, a junction part 24 to join it to the speaker cone paper 25, and a reinforcing member 22a installed inside the speaker surround 20a.

The reinforcing member 22a is a mesh member installed inside the speaker surround 20a, which is sandwiched between material such as urethane foam and integrated by for example heat molding. As material of the reinforcing member 22a, for example, aromatic polyamide fiber, cotton, polyester fiber, olefin fiber, nylon fiber and the like can be mentioned, which are molded into mesh in a form of plain weave.

Plain weave is consisted of mesh of biaxial weave with fibers being arranged in two direction, vertically and horizontally, warp 26a and weft 26b being crossing perpendicularly to each other. By this arrangement, therefore, the speaker surround 20a resistant to sideways motion can be constructed

### Second Example

Next, as shown in FIG. 4, the speaker surround 20b according to the second example of the invention is equipped with a roll part 21 with the curved central part, installed along the periphery of a cone-shaped speaker cone paper 25, a plane part 23 to fix it to a frame, a junction part 24 to join it to the speaker cone paper 25, and the reinforcing article 22b installed inside the speaker surround 20b.

The reinforcing member 22b is a mesh member installed inside the speaker surround 20b, which is sandwiched between material such as urethane foam and integrated by for example heat molding. As material of the reinforcing member 22b, for example, aromatic polyamide fiber, cotton, polyester fiber, olefin fiber, nylon fiber and the like can be mentioned, which are molded into mesh in a form of honeycomb weaving.

In the reinforcing member 22b in a form of honeycomb weaving, load on the speaker surround 20b will be distributed uniformly and therefore it will more effective to the object of this invention. Also as strength will be distributed uniformly with honeycomb weaving, the speaker will be applicable to further large amplitude.

### Third Example

Then, as shown in FIG. 5, the speaker surround 20c according to the third example of the invention is equipped with a roll part 21 with the curved central part, installed along the periphery of a cone-shaped speaker cone paper 25, a plane part 23 to fix it to a frame, a junction part 24 to join it to the speaker cone paper 25, and a reinforcing member 22c installed inside the speaker surround 20c.

The reinforcing member 22c is a mesh article installed inside the speaker surround 20c, which is sandwiched between material such as urethane foam and integrated by for example heat molding. As material of the reinforcing member 22bc, for example, aromatic polyamide fiber, cotton, polyester fiber, olefin fiber, nylon fiber and the like can be mentioned, which are molded into mesh in a form of triaxial weave.

In triaxial weave, the first warp 27 goes straight on the fabric plane at 60 degree, the second warp 28 intersects with the first warp 27 at 60 degree, going straightly in the opposite direction, and weft 29 intersects with each of the first warp 27 and the second warp 28, running in the horizontal direction. By arranging a reinforcing member 22c composed of this triaxial weave at a given degree, the speaker surround 20c with high strength especially in the direction of their warps and weft will be formed.

(An Example of Speakers Employing the Speaker Surround According to the Invention)

Next, referring to FIG. 6, a speaker 30 employing the speaker surround 20 according to the invention will be described. FIG. 6 is a cross-sectional view of the left half of the speaker 30.

The speaker 30 has a magnetic circuit composed of a yoke 36 and a plate 37, sandwiching a ring-shaped magnet 35. Into magnetic space 34 formed by the yoke 36 and the plate 37 is inserted a voice coil 33 rolled concentrically on a voice coil bobbin 32. The tip of the voice coil bobbin 32 is adhesively fixed to the speaker cone paper 25 through a dust cap 39. A frame 31 is fixed on the opposite plane to the magnet 35 on the plate 37. A damper 38 is installed between the frame 31 and the voice coil bobbin 32, and the voice coil 33 is supported and suspended by the damper 38 so that it will not contact with the yoke 36 and the plate 37 in the magnetic space 34. The speaker surround 20 is connected to the speaker cone paper 25 via the junction part 24, with the roll part 21 facing front, and to frame 31 via the plane part 23. An electrical junction part 40 is set at a given site outside the frame 31 and an electrical junction part 40 is utilized as a terminal to supply the drive current from a lead 41 to voice coil 33 via a lead wire for speaker 42.

When signal is input to the voice coil 33, force is generated in the direction indicated by the arrow L by a magnetic flux toward the direction of the radius of magnetic space 34 and concentric current flowing into the voice coil 33, vibrating the speaker cone paper 25 back and forth to convert vibration to audio. At the same time, the speaker surround 20 deforms according to the displacement of the speaker cone paper 25, supporting the posture of the speaker cone paper 25.

According to the speaker surround 20 of the invention, as it has a structure with no substantial flexibility in the direction of displacement by means of the action of the reinforcing member 22 thereof, the speaker surround 20 has sufficient strength property as well. Even with large amount of input, therefore, concerns of reduction of the audio quality by generation of unnecessary vibration such as sideways motion which results from sympathetic vibration of the speaker surround will be reduced. There is also no concern of tearing of it at the limit of amplitude. Furthermore, even when a speaker 30 is used with cabinet, no edge suction due to insufficient strength will occur, enabling reproduction of high-quality audio effectively.

(The Method for Producing Speaker Surround According to the Invention)

As the method for producing a speaker surround according to the invention, that is the one equipped with a mesh reinforcing member inside urethane foam to be installed between a speaker cone paper and a frame of a speaker, there may be mentioned a method as below.

First, a reinforcing member is sandwiched between thermoplastic resin films, and the urethane foam and the reinforcing member is fusion bonded by hot-press molding. As the thermoplastic resin film, nylon, ethylene vinyl acetate copolymer, or polypropylene can be employed.

Secondly, the mesh reinforcing member is impregnated with urethane resin or acrylic resin, polyvinyl alcohol resin, phenol resin, melamine resin or latex mixed phenol resin, and then urethane foam and the reinforcing member is fusion bonded by hot-press molding.

Thirdly, the mesh reinforcing member is fused by hot-press molding, and then fusion bonded to urethane foam.

As the fourth, using a mesh reinforcing member with large weave texture or stitch, urethane foam arranged on both sides of the reinforcing article is contacted directly to it via the weave texture or stitch, and then urethane foam on the both sides is fusion bonded.

As the fifth, solvent or emulsion adhesive is applied to urethane, the mesh reinforcing member is sandwiched between urethane, and then urethane and the reinforcing member are fusion bonded by hot-press molding.

It is inevitable that without limiting to the methods for producing the speaker surround abovementioned, any method which enables to produce a speaker surround according to the invention can be employed.

As described in detail hereinbefore, according to the speaker surround of the invention and the speaker employing thereof, as the speaker surround has sufficient strength property and the speaker cone paper and the frame can be joined firmly, concerns of reduction of the audio quality by generation of unnecessary vibration such as sideways motion which results from sympathetic vibration of the speaker surround will be reduced, even with large amount of input, and, tearing problem at the limit of amplitude will also be solved. Furthermore, even when using a speaker with cabinet, there will be no suction phenomenon of an edge due to insufficient strength, providing a speaker affording reproduction of high-quality audio.

In the Examples, as the reinforcing member 22, examples employing mesh composed of plain weave, honeycomb weaving, and triaxial weave have been described, although they shall not be limiting examples. As material to be employed, aromatic polyamide fiber, cotton, polyester fiber, olefin fiber, nylon fiber and the like have been mentioned; however any material can be employed as long as the material has similar property.

This invention is not limited to the preferred embodiments described above and can be altered suitably within the scope which will not depart from the abstract or spirit of the invention readable from the following claims and the whole specification, the speaker surround with such alterations and the method for producing thereof being intended to be encompassed within the spirit of the invention.

The entire disclosure of Japanese Patent Application No. 2002-289647 filed on Oct. 2, 2002 including the specification, claims, drawings and summary is incorporated herein by reference in its entirety.

What is claimed is:

1. A speaker surround arranged between a diaphragm and a frame of a speaker, the speaker surround comprising:
a reinforcing member installed inside urethane foam, the reinforcing member being the one with no expansion and contraction upon deformation based on the displacement of the diaphragm.

2. The speaker surround according to claim 1, wherein the reinforcing member is a mesh reinforcing member.

3. The speaker surround according to claim 1, wherein the reinforcing member is made of any one of aromatic polyamide fiber, cotton, polyester fiber, olefin fiber and nylon fiber.

4. The speaker surround according to claim 1, wherein the reinforcing member comprises any one of plain weave, honeycomb weaving and triaxial weave.

5. The speaker surround according to claim 1, wherein the reinforcing member is made of any one of nonwoven fabric and triaxial combined nonwoven fabric.

6. A method for producing a speaker surround comprising a mesh reinforcing member inside urethane foam, the method comprising the processes of:
sandwiching the reinforcing member between thermoplastic resin films; and
fusion bonding the urethane foam and the reinforcing member by hot-press molding.

7. The method for producing a speaker surround according to claim 6, wherein the thermoplastic resin film comprises nylon.

8. The method for producing a speaker surround according to claim 6, wherein the thermoplastic resin film comprises ethylene vinyl acetate copolymer.

9. The method for producing a speaker surround according to claim 6, wherein the thermoplastic resin film comprises polypropylene.

10. A method for producing a speaker surround comprising a mesh reinforcing member inside urethane foam, the method comprising the processes of:
impregnating the mesh reinforcing member with urethane resin, acrylic resin, polyvinyl alcohol resin, phenol resin, melamine resin or latex mixed phenol resin; and
fusion bonding the urethane foam and the reinforcing member by hot-press molding.

11. A method for producing a speaker surround comprising a mesh reinforcing member inside urethane foam, the method comprising the processes of:
fusing the mesh reinforcing member by hot-press molding; and
fusion bonding the mesh reinforcing member to the urethane foam.

12. A method for producing a speaker surround comprising a mesh reinforcing member inside urethane foam, wherein
the mesh reinforcing member has large weave texture or stitch, and
the method comprises the processes of:
contacting the urethane foam arranged on both sides of the reinforcing member directly to the reinforcing member via the weave texture or stitch; and
fusion bonding the urethane foam on both sides to the reinforcing member by hot-press molding.

13. A method for producing a speaker surround comprising a mesh reinforcing member inside urethane foam, the method comprising the processes of:
applying solvent or emulsion adhesive to urethane;
sandwiching a mesh reinforcing member by the urethane; and
fusion bonding the urethane and reinforcing member by hot-press molding.
